(19) United States
(12) Patent Application Publication
(10) Pub. No.: US 2014/0042961 A1
(43) Pub. Date: Feb. 13, 2014

(54) Electronic Device and Method for Detecting Swelling of Battery Thereof

(71) Applicant: COMPAL ELECTRONICS, INC., Taipei City (TW)

(72) Inventor: Chi-MIng LAN, Taipei City (TW)

(73) Assignee: COMPAL ELECTRONICS, INC., Taipei City (TW)

(21) Appl. No.: 13/962,763

(22) Filed: Aug. 8, 2013

Related U.S. Application Data
(60) Provisional application No. 61/682,300, filed on Aug. 12, 2012.

(51) Int. Cl. H01M 2/34

(52) U.S. Cl. CPC H01M 2/345
USPC 320/107; 429/61; 429/50

(57) ABSTRACT

Disclosed herein are an electronic device and a method for detecting the swelling of a battery The electronic device includes a battery module, a swelling detection module, and a system. The battery module includes at least one battery therein. The deformation module is deposed within the battery module and is configured to detect the swelling of the battery thereby generating a signal. The system is configured to receive the signal directly transmitted from the deformation module, and to determine whether the signal is greater than a first setting value or less than a second setting value, such that when the signal is greater than the first setting value or less than the second setting value, the system activates a protection mechanism to prevent the battery from further swelling.

### RELATED APPLICATIONS

This application claims priority to U.S. Patent Application No. 61/682,300, filed Aug. 12, 2012 the entirety of which is herein incorporated by reference.

### BACKGROUND

1. Technical Field

The present disclosure relates to an electronic device, and more particularly, an electronic device and a method for detecting the swelling of a battery of the electronic device.

2. Description of Related Art

In recent years, new electronic products (e.g., notebooks, smart phones, tablets, etc.) constantly enter the market with novel functions. Concerning the developing trends in portability, the electronic products like cell phones and the notebooks are often equipped with rechargeable batteries.

After a long use for a rechargeable battery, the body of the battery may swell, due to the pressure from the internal gas or chemical reaction inside the battery, which is potentially dangerous. To detect the swelling of the battery, U.S. Pat. No. 7,826,189 discloses a battery casing 100 having its external surface surrounded by bar-like conductive members, wherein the two ends of the conductive member overlap with a length Lₒ (as illustrated in FIG. 1), and when the battery swells, the two overlapping ends move horizontally thereby shortening the length Lₒ, so as to detect the swelling of the battery.

However, when the temperature of the battery rises, the length Lₒ would also be affected; the material aging of the casing 100 would also affect the length Lₒ. In view of the foregoing, there exist problems and disadvantages in the art that needs further improvement, but those skilled in the art sought vainly for a solution. There is an urgent need to detect the swelling of the battery to solve or circumvent above problems and disadvantages.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides an electronic device and a method for detecting the swelling of a battery so as to overcome the problems which has faced the prior art

According to one embodiment of the present disclosure, an electronic device comprises a battery module, a swelling detection module and a system. The battery module comprises at least one battery therein. The swelling detection module is disposed within the battery module, and configured to detect the swelling of the battery thereby generating a signal. The system is configured to receive the signal directly transmitted from the swelling detection module, and to determine whether the signal is greater than a first setting value or less than a second setting value, such that when the signal is greater than the first setting value or less than the second setting value, activate a protection mechanism to prevent the battery from further swelling.

The swelling detection module comprises a resistor and a strain gauge. The resistor is connected to a system voltage source, and the strain gauge is in series connection with the resistor; when the battery swells, a resistance value of the strain gauge increases, the system directly receives the voltage on the strain gauge as the signal and determines whether the voltage is greater than the first setting value.

Alternatively, the swelling detection module comprises a resistor and a pressure sensor. The resistor is connected to a system voltage source, and the pressure sensor is in series connection with the resistor; a pressure resulted from the swelling of the battery causes a decrease in the resistance value of the pressure sensor, the system directly receives the voltage on the pressure sensor as the signal and determines whether the voltage is less than the second setting value.

The swelling detection module is disposed on an internal surface of a casing of the battery module, or on a surface of a battery core of the battery disposed within the battery module.

The system comprises a charger and an embedded controller; the charger is connected to battery module. When the protection mechanism is activated, the embedded controller is configured to command the charger to stop charging the battery module; alternatively, when the protection mechanism is activated, the embedded controller is configured to latches charger, thereby stopping charging the battery module.

The swelling detection module is connected to a stand-alone battery, wherein the stand-alone battery is not connected to the system.

The system includes an embedded controller, and the embedded controller is configured to receive and determine the signal, and then, uses a determination result to activate the protection mechanism.

According to another embodiment of the present disclosure, a method for detecting the swelling of a battery suitable for use in an electronic device is provided. The electronic device has a battery module comprising a battery disposed therein. The method comprises the following steps: (a) using a system to receive a signal directly transmitted from a swelling detection module, wherein the swelling detection module is disposed within the battery module and configured to detect the swelling of the battery, such that the system determines whether the signal is greater than a first setting value or less than a second setting value; and (b) when the signal is greater than the first setting value or less than the second setting value, using the system to activate a protection mechanism to prevent the battery from further swelling.

The swelling detection module comprises a resistor and a strain gauge; the resistor is connected to a system voltage source, and the strain gauge is in series connection with the resistor; step (a) comprises: when the battery swells, a resistance value of the strain gauge increases, using the system to directly receive the voltage on the strain gauge as the signal and to determine whether the voltage is greater than the first setting value.

Alternatively, the swelling detection module comprises a resistor and a pressure sensor; the resistor is connected to a system voltage source, and the pressure sensor is in series connection with the resistor; the step (a) comprises: when a pressure resulted from the swelling of the battery causes a decrease in the resistance value of the pressure sensor, using the system to directly receive the voltage on the pressure sensor as the signal and to determine whether the voltage is less than the second setting value.

The system comprises a charger; the charger is connected to battery module; the step (b) comprises: when the protection mechanism is activated, commanding the charger to stop charging the battery module; alternatively, when the protection mechanism is activated, latching the charger thereby stopping charging the battery module.

According to another embodiment of the present disclosure, an electronic device comprises a battery module, a swelling detection module and a system. The battery module comprises a casing and at least one battery; the battery is disposed within the casing; the swelling detection module is disposed within the battery module; the swelling detection module comprises a first conductor and a second conductor; the first conductor is fixed on the internal surface of the casing; the second conductor is fixed on the battery and faces the first conductor, such that when the battery swells, the first and second conductors contact each other. When the first and second conductors contact each other, the system is configured to activate a protection mechanism to prevent the battery from further swelling.

The first conductor is a metal sheet and the second conductor is an electric contact; alternatively, the first conductor is an electric contact and the second conductor is a metal sheet.

The system comprises a charger and an embedded controller; the charger is connected to the battery module. When the protection mechanism is activated, the embedded controller is configured to command the charger to stop charging the battery module; alternatively, when the protection mechanism is activated, the embedded controller is configured to latches the charger, thereby stopping charging the battery module.

According to another embodiment of the present disclosure, a method for detecting the swelling of a battery, suitable for use in an electronic device is provided. The electronic device comprises a casing, at least one battery, a first conductor and a second conductor; the battery is disposed within the casing; the first conductor is fixed on the internal surface of the casing; the second conductor is fixed on the battery and faces the first conductor. The method comprises: (a) using a swelling detection module to detect the swelling of the battery; the swelling detection module comprises a first conductor and a second conductor; the first conductor is fixed on the internal surface of the casing; the second conductor is fixed on the battery and faces the first conductor, such that when the battery swells, the first and second conductors contact each other; (b) when the first and second conductors contact each other, using a system to activate a protection mechanism to prevent the battery from further swelling.

The first conductor is a metal sheet and second conductor is an electric contact; alternatively, the first conductor is an electric contact and the second conductor is a metal sheet.

The system comprises a charger; the charger is connected to the battery module; the step (b) comprises: when the protection mechanism is activated, commanding the charger to stop charging the battery module; alternatively, when the protection mechanism is activated, latching the charger thereby stopping charging the battery module.

The system comprises an embedded controller, and the embedded controller is configured to receive and determine a signal transmitted from the swelling detection module, and then using a determination result to activate the protection mechanism.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. Effectively detecting whether the battery swells; and

2. Using a protection mechanism to avoid the battery from further swelling.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic diagram illustrating a portion of a battery module according to prior art;

FIG. 2 is a schematic diagram illustrating an equivalent circuit of an electronic device according to one embodiment of the present disclosure;

FIG. 3A is a sectional view illustrating an electronic device according to one embodiment of the present disclosure;

FIG. 3B is a sectional view illustrating an electronic device according to another embodiment of the present disclosure;

FIG. 4 is a flow chart illustrating the operation method of an electronic device according to one embodiment of the present disclosure;

FIG. 5 is a sectional view illustrating an electronic device according to another embodiment of the present disclosure;

FIG. 6 is a schematic diagram illustrating an equivalent circuit of an electronic device according to another embodiment of the present disclosure; and

FIG. 7 is a flow chart illustrating a method for detecting the swelling of a battery according to one embodiment of the present disclosure.

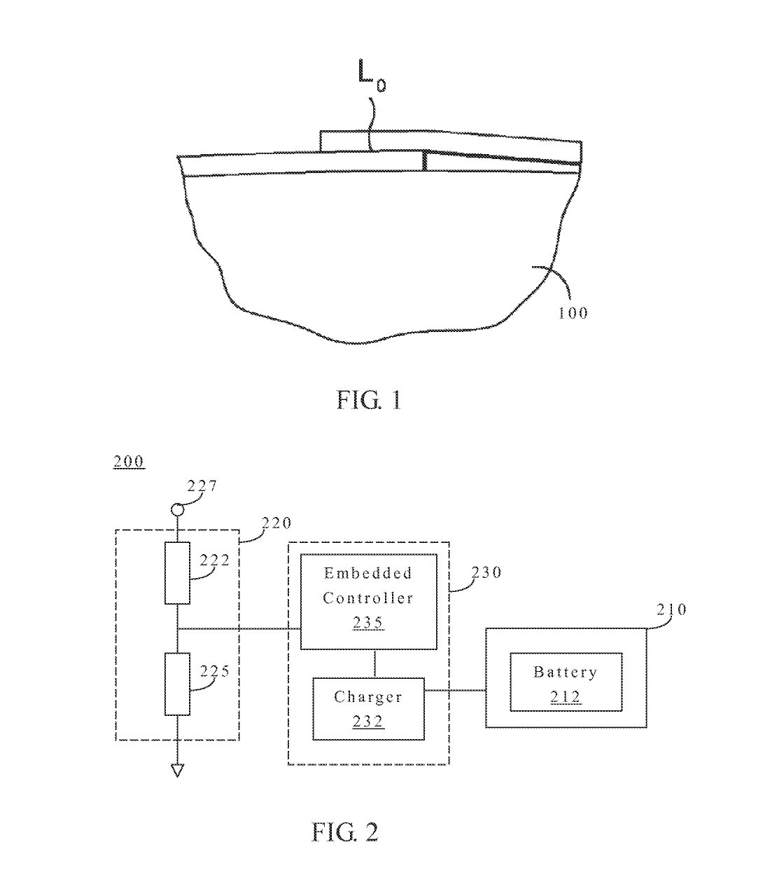

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

FIG. 2 is a schematic diagram illustrating an equivalent circuit of an electronic device 200 according to one embodiment of the present disclosure. The electronic device 200 comprises a battery module 210, a swelling detection module 220 and a system 230. In structure, the battery module 210 has at least one battery 212 disposed therewithin. In operation, the swelling detection module 220 is configured to detect the swelling of the battery 212, thereby generating a signal. The system 230 is configured to directly receives the signal transmitted from the swelling detection module 220, and determine whether the signal is greater than a first setting value or less than a second setting value, such that when the signal is greater than the first setting value or less than the second setting value, the system 230 activates a protection mechanism to prevent the battery 212 from further swelling and jeopardizing the electronic device. In one embodiment of the present disclosure, the swelling detection module 220 may be connected to an embedded controller in the system, such that the embedded controller is used to determine the signal transmitted from the swelling detection module.

The swelling detection module 220 comprises a resistor 222 and resistance change component 225. In structure, the resistor 222 is connected to the system power supply 227 such that the system power supply 227 charges the swelling detection module; the resistance change component 225 is in series connection with the resistor 222. In one embodiment, the resistance change component 225 is a strain gauge; when the battery 212 swells, a resistance value of the strain gauge increases, and the system 230 directly receives a voltage on the strain gauge and uses the voltage as the signal, and determines whether the voltage on the strain gauge is greater than the first setting value. For example, if the voltage of the system power supply 227 is 3.3V and the voltage of the resistor 222 is 1 kΩ, the first setting value can be 2V. Depending on the design of the product, the swelling detection module may also use a stand-alone battery to supply electricity thereto; rather than being connected to the system power supply.

Alternatively, in another embodiment, the resistance change component 225 is a pressure sensor. The swelling of the battery 212 will create a pressure, and this pressure will cause the resistance value of the pressure sensor to decrease; the system 230 directly receives the voltage on the pressure sensor and uses the voltage as the signal, and determines whether the voltage on the pressure sensor is less than the second setting value. For example, if the voltage of the system power supply 227 is 3.3V and the voltage of the resistor 222 is 1 kΩ, the second setting value may be 1V.

In one embodiment, said protection mechanism means that the system 230 stops charging the battery module 210. As illustrated in FIG. 2, the system 230 comprises a charger 232 and an embedded controller 235. In structure, the charger 232 is connected to the battery module 210. The embedded controller 235 is configured to receive and determine the signal transmitted from the swelling detection module 220, and then use a determination result to activate the protection mechanism. When the protection mechanism is activated, the embedded controller 235 is configured to command the charger 232 to stop charging the battery module 210, so as to prevent the battery 212 from further swelling and jeopardizing the electronic device. When the system 230 determines that the battery module 210 has returned to normal based on the signal transmitted from the swelling detection module 220, the embedded controller 235 in the system 230 will command the charger 232 to re-start the charging of the battery module 210.

Alternatively, when the protection mechanism is activated, the embedded controller is configured to latch the charger 232, thereby stopping charging the battery module 210, so as to prevent the battery 212 from further swelling. When the user intends to turn on the charger 232, the user has to unplug and then re-plug the battery module so as to re-connect the battery module 210 and the system 230 for the purpose of turning on the charger 232.

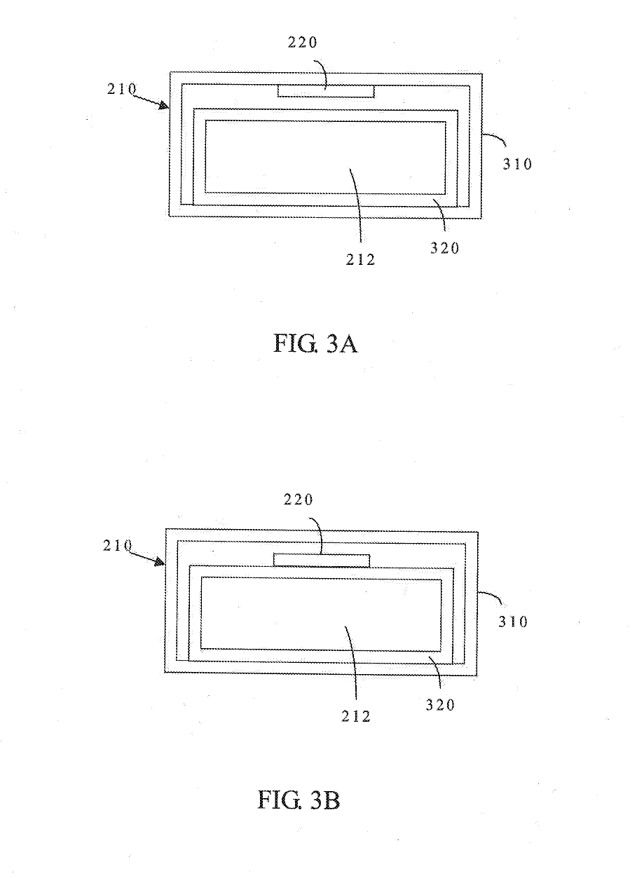

FIG. 3A is a sectional view illustrating an electronic device 200 according to one embodiment of the present disclosure. As illustrated in FIG. 3A, the swelling detection module 220 is disposed within the battery module 210; specifically, the swelling detection module 220 is disposed on the internal surface of the casing 310 of the battery module 210, so as to prevent the effects resulted from the exterior environment.

FIG. 3B is a sectional view illustrating an electronic device 200 according to another embodiment of the present disclosure. As illustrated in FIG. 3B, the swelling detection module 220 is disposed within the battery module 210; specifically, the swelling detection module 220 is disposed on the surface of the battery core casing 320 of the battery 212 in the battery module 210, so as to prevent the effects resulted from the exterior environment.

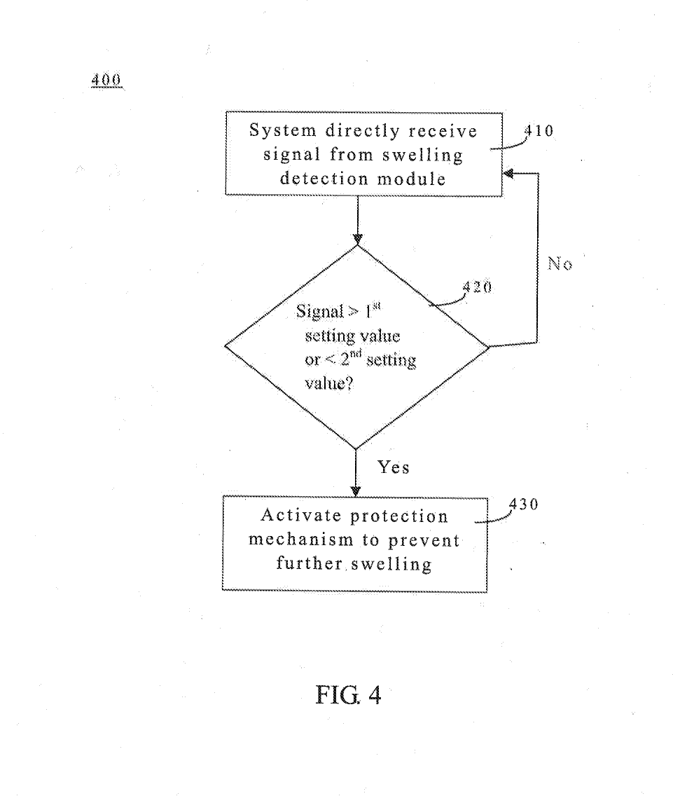

FIG. 4 is a method 400 for detecting the swelling of a battery according to one embodiment of the present disclosure; the method 400 is suitable for use in the electronic device(s) 200 described above. As illustrated in FIG. 4, method 400 comprises the steps 410 to 430. It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed.

In step 410, a system is used to directly receive a signal transmitted from a detection module, wherein the swelling detection module is disposed within the battery module and configured to detect the swelling of the battery. In step 420, the system is used to determine whether the signal is greater than a first setting value or less than a second setting value. In step 420, when the signal is greater than the first setting value or less than the second setting value, the system is used to activate a protection mechanism to prevent the battery from further swelling.

In one embodiment, the swelling detection module comprises a resistor and a strain gauge; the resistor is connected to a system voltage source; the strain gauge is in series connection with the resistor; and step 410 comprises: when the battery swells, and the resistance value of the strain gauge increases, using the system to directly receive the voltage on the strain gauge as the signal; and in step 420, using the system to determine whether the voltage is greater than the first setting value.

Alternatively, in another embodiment, the swelling detection module comprises a resistor and a pressure sensor; the resistor connected to a system voltage source; the pressure sensor is in series connection with the resistor; and step 410 comprises: when the pressure resulted from the swelling of the battery causes the decrease of the resistance value on the pressure sensor, using the system to directly receive the voltage on the pressure sensor as the signal; and in step 420, using the system to determine whether the voltage is less than the second setting value.

The system comprises a charger; the charger is connected to the battery module; and step 430 comprises: when the protection mechanism is activated, commanding the charger to stop charging the battery module, thereby preventing the battery from further swelling. Alternatively, step 430 comprises: when the protection mechanism is activated, latching the charger, thereby stopping charging the battery module, so as to avoid the battery from further swelling. When the user intends to turn on the charger, the user has to re-connect the battery module and the system so as to turn on the charger and continue to use the signal transmitted from the swelling detection module to determine whether the battery module swells.

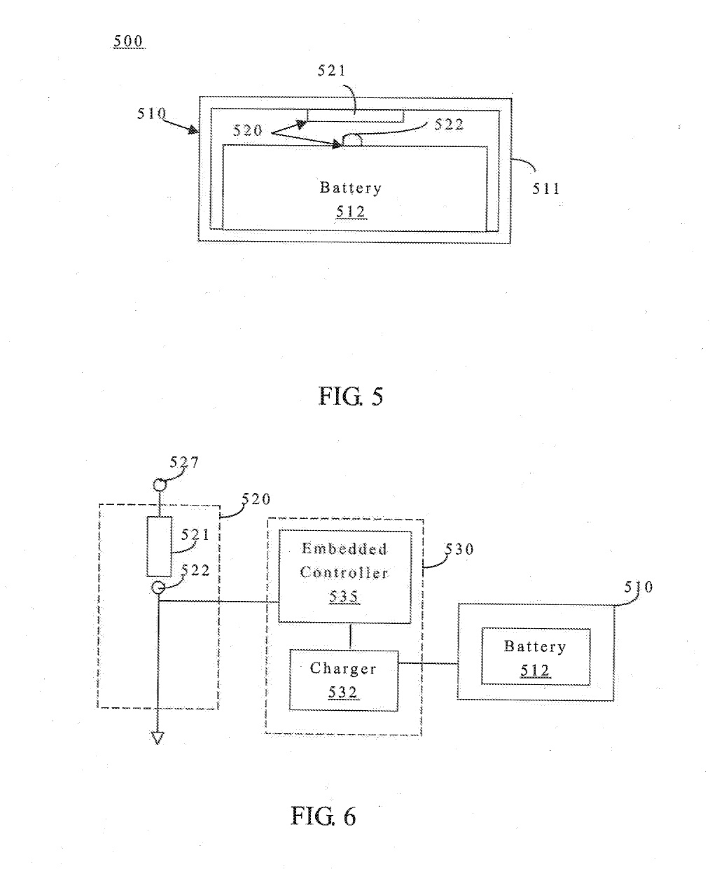

FIG. 5 is a sectional view illustrating an electronic device 500 according to another embodiment of the present disclosure. The electronic device 500 comprises a battery module 510 and a swelling detection module 520. The battery module 510 comprises a casing 511 and a battery 512; the battery 512 is disposed within the casing 511; the swelling detection module 520 is disposed within the battery module 510; the swelling detection module 520 comprises a first conductor 521 and a second conductor 522; the first conductor 521 is fixed on the internal surface of the casing 511I the second conductor 522 is fixed on the battery 512 and faces the first conductor 511, such that when the battery 512 swells, the first conductor 521 and the second conductor 522 contact each other.

In FIG. 5, the first conductor 521 is a metal sheet and the second conductor 522 is an electric contact; however, the present invention is not limited thereto. In practice, the arrangement of the metal sheet and the electric contact may be interchangeable; that is, the first conductor may be an electric contact and the second conductor may be a metal sheet. In one embodiment, the swelling detection module 520 is connected to a stand-alone battery 512, wherein the stand-alone battery 512 is not connected to said system.

FIG. 6 is a schematic diagram illustrating an equivalent circuit of an electronic device 500 according to another embodiment of the present disclosure. The electronic device 500 comprises a system 530; when the first conductor 521 and the second conductor 522 contact each other, the system 530 is configured to activate a protection mechanism to prevent the battery 512 from further swelling. In FIG. 6, the system power supply 527 is connected to the first conductor 521; the system 530 is connected to the second conductor 522; the system 530 determines whether the first conductor 521 and the second conductor 522 contact each other based on the presence or absence of the voltage input. Alternatively, the system voltage source may be connected to a second conductor, and the system is connected to the first conductor; persons having ordinary skill in the art can flexibly select any suitable arrangement depending on the actual need.

In one embodiment, said protection mechanism means that the system 530 will stop charging the battery module 510. As illustrated in FIG. 5, the system 530 comprises a charger 532 and an embedded controller 535. In structure, the charger 532 is connected to the battery module 510. The embedded controller 535 is configured to receive and determine the signal transmitted from the swelling detection module 520, and then use a determination result to activate the protection mechanism. When the protection mechanism is activated, the embedded controller 535 is configured to command the charger 532 to stop charging the battery module 510, so as to prevent the battery 512 from further swelling.

Alternatively, when the protection mechanism is activated, the embedded controller 535 is configured to latch the charger 532, thereby stopping charging the battery module 510, so as to prevent the battery 512 from further swelling. When the user intends to turn on the charger 532, the user has to re-connect the battery module 510 and the system 530 so as to turn on the charger 532.

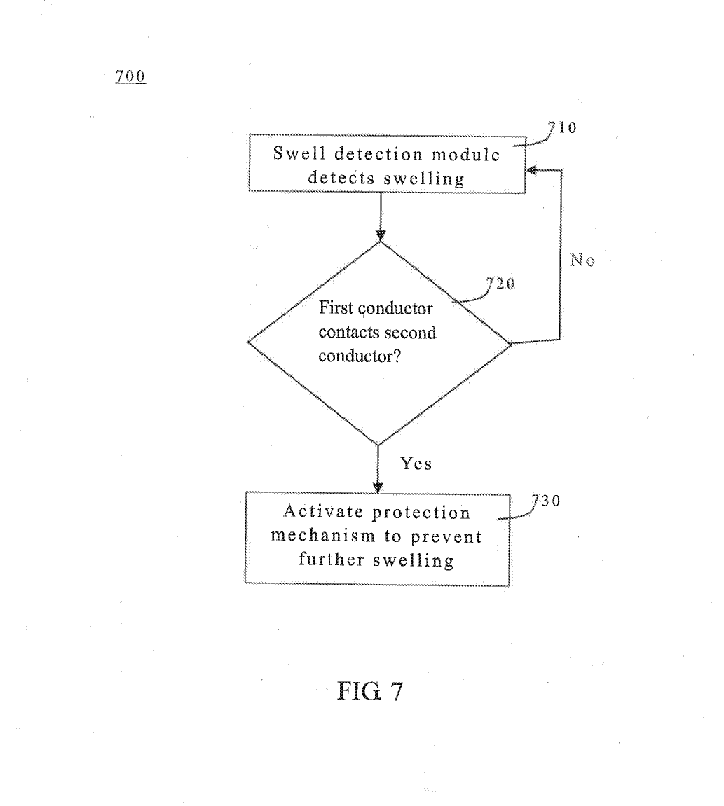

FIG. 7 is a method 700 for detecting the swelling of a battery according to one embodiment of the present disclosure; the method 700 is suitable for use in the above-described electronic device(s) 500. As illustrated in FIG. 7, the detecting method 700 comprises steps 710 to 730. It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed.

In step 710, using a swelling detection module to detect the swelling of the battery; the swelling detection module comprises a first conductor and a second conductor; the first conductor is fixed on the internal surface of the casing, the second conductor is fixed on the battery and faces the first conductor, such that when the battery swells, the first and the second conductors contact each other. In step 720, determine whether the first and second conductors contact each other. In step 730, when the first and the second conductors contact each other, a system is used to activate a protection mechanism to prevent the battery from further swelling.

The system comprises a charger; the charger is connected to the battery module; and step 730 comprises: when the protection mechanism is activated, commanding the charger to stop charging the battery module, so as to prevent battery from further swelling. Alternatively, step 730 comprises: when the protection mechanism is activated, latching the charger, thereby stopping charging the battery module, so as to avoid the battery from further swelling. When the user intends to turn on the charger, the user has to re-connect the battery module and the system to turn on the charger.

In view of the foregoing, the present invention can effectively detect whether the battery swells, and in the case where the battery swells, the present invention can avoid the battery from further swelling by a protection mechanism.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. An electronic device, comprising:
a battery module, comprising at least one battery therein;
a swelling detection module, disposed within the battery module and configured to detect the swelling of the battery thereby generating a signal; and
a system, configured to receive the signal directly transmitted from the swelling detection module and to determine whether the signal is greater than a first setting value or less than a second setting value, such that when the signal is greater than the first setting value or less than the second setting value, the system activates a protection mechanism to prevent the battery from further swelling.

2. The electronic device according to claim 1, wherein the swelling detection module comprises:
a resistor, connected to a system voltage source; and
a strain gauge, in series connection to the resistor,
wherein when the battery swells, a resistance value of the strain gauge increases, the system directly receives the voltage on the strain gauge as the signal and determines whether the voltage is greater than the first setting value.

3. The electronic device according to claim 1, wherein the swelling detection module comprises:
a resistor, connected to a system voltage source; and
a pressure sensor, in series connection to the resistor,
wherein a pressure resulted from the swelling of the battery causes a decrease in the resistance value of the pressure sensor, and the system directly receives the voltage on the pressure sensor as the signal and determines whether the voltage is less than the second setting value.

4. The electronic device according to claim 1, wherein the swelling detection module is disposed on an internal surface of a casing of the battery module, or on a surface of a battery core of the battery disposed within the battery module.

5. The electronic device according to claim 1, wherein the system comprises:
a charger, connected to the battery module; and
an embedded controller, configured to, when the protection mechanism is activated, command the charger to stop charging the battery module.

6. The electronic device according to claim 1, wherein the system comprises:
a charger, connected to the battery module; and
an embedded controller, configured to, when the protection mechanism is activated, latch the charger, thereby stopping charging the battery module.

7. The electronic device according to claim 1, wherein the swelling detection module is connected to a stand-alone battery, wherein the stand-alone battery is not connected to the system.

8. The electronic device according to claim 1, wherein the system comprises an embedded controller, wherein the embedded controller is configured to receive and determine the signal, and then use a determination result to activate the protection mechanism.

9. A method for detecting the swelling of a battery, suitable for use in an electronic device which comprises a battery module having the battery disposed therein, the method comprising:
(a) using a system to receive a signal directly transmitted from a swelling detection module, wherein the swelling detection module is disposed within the battery module and configured to detect the swelling of the battery, such that the system determines whether the signal is greater than a first setting value or less than a second setting value; and
(b) when the signal is greater than the first setting value or less than the second setting value, using the system to activate a protection mechanism to prevent the battery from further swelling.

10. The method according to claim 9, wherein the swelling detection module comprises a resistor and a strain gauge, wherein the resistor is connected to a system voltage source, and the strain gauge is in series connection with the resistor, and the step (a) comprises:
when the battery swells, a resistance value of the strain gauge increases, using the system to directly receive the voltage on the strain gauge as the signal, and determine whether the voltage is greater than the first setting value.

11. The method according to claim 9, wherein the swelling detection module comprises a resistor and a pressure sensor, wherein the resistor is connected to a system voltage source, and the pressure sensor is in series connection with the resistor, and the step (a) comprises:
when a pressure resulted from the swelling of the battery causes a decrease in the resistance value of the pressure sensor, using the system to directly receive the voltage on the pressure sensor as the signal and determine whether the voltage is less than the second setting value.

12. The method according to claim 9, wherein the system comprises a charger, wherein the charger is connected to the battery module, and the step (b) comprises:
when the protection mechanism is activated, commanding the charger to is stop charging the battery module.

13. The method according to claim 9, wherein the system comprises a charger, wherein the charger is connected to the battery module, and the step (b) comprises:
when the protection mechanism is activated, latching the charger thereby stopping charging the battery module.

14. The method according to claim 9, wherein the system comprises an embedded controller, wherein the embedded controller is configured to receive and determine the signal, and then use a determination result to activate the protection mechanism.
